(19) United States
(12) Patent Application Publication
(10) Pub. No.: US 2018/0060800 A1
(43) Pub. Date: Mar. 1, 2018

(54) LOCKER BANKS WITH AUTOMATICALLY OPENING DOORS

(71) Applicant: United Parcel Service of America, Inc., Atlanta, GA (US)

(72) Inventor: Kalin Robinson, John's Creek, GA (US)

(21) Appl. No.: 15/252,629

(22) Filed: Aug. 31, 2016

(51) Int. Cl. G06Q 10/08; G07C 9/00

(52) U.S. Cl. CPC G06Q 10/083; G07C 9/00182

(57) ABSTRACT

A remote locker bank control system is configured to facilitate wireless control of a locker bank computer using a mobile computing device. The system may increase the ease with which a delivery driver can deliver parcels to the locker bank. As the driver approaches the locker bank to deliver a parcel, the system may automatically open a wireless communication channel between the driver's mobile computing device and the locker bank computer. The system may then transmit a scan of the parcel from the mobile computing device to the locker bank computer via the wireless communication channel. Next, the system may automatically open an available locker in the locker bank that is most proximate to the delivery driver, for example, to minimize a number of steps he or she must take to deliver the parcel to the locker.

### BACKGROUND

Delivering parcels and other items to locker banks can be time-consuming for delivery drivers, particularly those who are handling large volumes of deliveries. Logistics providers may desire to reduce inefficiencies in the delivery process. Accordingly, there is a need for improved systems and processes for facilitating the delivery of parcels and other items to locker banks.

### SUMMARY OF THE VARIOUS EMBODIMENTS

A computerized locker network comprises a plurality of locker banks, each respective locker bank comprising: (1) one or more locker bank computers comprising one or more processors and memory; and (2) one or more selectively securable locker compartments, each selectively securable locker compartment comprising one or more doors and one or more locking mechanisms. In particular embodiments, the one or more processors are configured to operate the one or more locking mechanisms to open the one or more doors. In various embodiments, the one or more locker bank computers further comprise one or more proximity sensors. In various embodiments, the computerized locker network also comprises a plurality of mobile computing devices. Each respective mobile computing device may, for example, comprises one or more processors and memory. In some embodiments, the one or more processors are configured to form a wireless communication channel between the respective mobile computing device and one or more particular locker bank computers in response to determining that the respective mobile computing device is within a particular distance of a particular locker bank of the plurality of locker banks that comprises the one or more particular locker bank computers.

In various embodiments, the computerized locker network further comprises one or more remote logistics servers, which comprise one or more processors and memory that stores one or more pieces of package level detail information and tracking information for a plurality of parcels. In various embodiments, the one or more processors are configured to update the tracking information for the plurality of parcels. The computerized locker network, in various embodiments, is configured for: (1) receiving, at the one or more logistics servers via one or more networks, identifying information for a particular parcel of the one or more parcels from a particular mobile computing device of the plurality of mobile computing devices following an unsuccessful delivery attempt of the particular parcel at a primary delivery location; (2) determining a minimum locker size for the particular parcel based on the package level detail information; (3) determining that the particular mobile computing device is within the particular distance of the particular locker bank; (4) automatically forming a wireless communication channel between the respective mobile computing device and the one or more particular locker bank computers in response to determining that the particular mobile computing device is within the particular distance of the particular locker bank; (5) receiving, from the particular mobile computing device, the identifying information for the particular parcel at a first time after automatically forming the wireless communication channel; (6) determining a location of the particular mobile computing device at the first time; (7) transmitting the identifying information for the particular parcel from the particular mobile computing device to the one or more particular locker bank computers via the wireless communication channel; (8) in response to transmitting the identifying information for the particular parcel from the particular mobile computing device to the one or more particular locker bank computers via the wireless communication channel: (a) determining which particular locker of the one or more selectively securable locker compartments of the particular locker bank is at least the minimum locker size, currently not storing any parcels, and most proximate to the location of the particular mobile computing device at the first time; and (b) automatically operating the one or more locking mechanisms to open the one or more doors of the particular locker.

A computer-implemented method of facilitating delivery of a first parcel to a locker bank, according to various embodiments, comprises: (1) determining, by one or more processors, whether one or more wireless communication initiation conditions have been met; (2) at least partially in response to determining that the one or more wireless communication initiation conditions have been met, initiating, by one or more processors, a direct wireless communication channel between the mobile computing device and a locker bank computer associated with the locker bank; (3) receiving, by one or more processors, at the locker bank computer, a request to deliver the first parcel to the locker bank from the mobile computing device via the direct wireless communication channel; (4) in response to receiving the request to deliver the first parcel: (i) determining, by one or more processors, a location of the mobile computing device; and (ii) determining, by one or more processors, based on the location of the mobile computing device, which of one or more lockers at the locker bank is a most proximate locker to the location of the mobile computing device; and (5) automatically opening, by one or more processors, the most proximate locker.

A locker delivery system, according to particular embodiments, comprises: (1) a locker bank computer associated with a locker bank comprising one or more processors and memory; and (2) a mobile computing device comprising one or more processors and memory. In particular embodiments, the locker bank comprises one or more selectively securable locker compartments, each selectively securable locker compartment comprising one or more doors and one or more locking mechanisms. In various embodiments, the locker delivery system is configured for: (1) receiving an indication that a first parcel is scheduled for delivery at the locker bank; (2) retrieving package level detail information associated with the first parcel, the package level detail information comprising one or more dimensions of the first parcel; (3) determining whether one or more wireless communication initiation conditions have been met; (4) at least partially in response to determining that the one or more wireless communication initiation conditions have been met, initiating a direct wireless communication channel between the mobile computing device and the locker bank computer; and (5) receiving, at the locker bank computer, a request to deliver the first parcel to the locker bank from the mobile computing device via the direct wireless communication channel. In some embodiments, in response to receiving the request to deliver the first parcel, the locker delivery system is further configure for: (1) determining a location of the mobile computing device; (2) determining, based on the location of the mobile computing device and the one or more dimensions of the first parcel, which of the one or more selectively securable locker compartments is a most proximate locker to the location of the mobile computing device that is sufficiently large to accommodate the first parcel; and (3) causing the one or more locking mechanisms to unlock the one or more doors of the most proximate locker.

### BRIEF DESCRIPTION OF THE DRAWINGS

Various embodiments of a remote locker bank control system are described below. In the course of this description, reference will be made to the accompanying drawings, which are not necessarily drawn to scale, and wherein:

FIG. 1 is a block diagram of a remote locker bank control system in accordance with an embodiment of the present system;

FIG. 2 is a schematic diagram of a computer, such as the logistics server of FIG. 1, that is suitable for use in various embodiments;

FIG. 3 is an exemplary locker bank, such as the one or more locker banks of FIG. 1, that is suitable for use in various embodiments;

FIG. 4 depicts a flow chart that generally illustrates various steps executed by a Parcel Delivery to Locker Bank Module that, for example, may be executed by the logistics server of FIG. 1;

FIG. 5 depicts an exemplary delivery driver experience according to a particular embodiment of the system.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A remote locker bank control system, according to various embodiments, is configured to facilitate a straightforward delivery of one or more parcels to a computerized locker bank by, for example, reducing a number of steps that a delivery driver must take in order to ultimately place the one or more parcels in one or more particular lockers. The remote locker bank control system may facilitate the delivery by, for example, enabling a delivery driver to control the computerized locker bank (e.g., the locker bank computer 130) using a mobile computing device.

When a delivery driver arrives at a locker bank to deliver one or more parcels (e.g., or other items), the system may, in various embodiments, automatically open a wireless communication channel between the driver's mobile computing device 180 and a locker bank computer 130 associated with the locker bank 170. The system may, for example, open the wireless communication channel in response to determining that the delivery driver (e.g., the delivery driver's mobile computing device 180) is within a particular distance of the suitable locker bank (e.g., the locker bank computer), is within range of a wireless receiver (e.g., wireless antennae) associated with the locker bank computer, etc. In various embodiments, the wireless communication channel allows the mobile computing device to transmit data such as parcel size information (and any other information) and other input data directly from the mobile computing device 180 to the locker bank computer 130 in addition to controlling operation of the locker bank computer (e.g., by serving as an input device for the locker bank computer).

Once the wireless communication channel is open, the system receives a scan of the item from the delivery driver's mobile computing device. The system, in particular embodiments, then causes the locker bank computer to automatically open an available locker so that the delivery driver can place the item inside. In particular embodiments, the system is further configured to determine which of a potential plurality of available lockers within the locker bank is most proximate to the delivery driver (e.g., to the delivery driver's mobile computing device 180) prior to opening the available locker. In various embodiments, the system further uses dimension and/or size information associated with the item to determine an available locker within the locker bank that is at least large enough to house the item in addition to determining the most proximate locker. By opening the most proximate locker to the delivery driver that will fit the item, the system may enable the delivery driver to minimize a number of steps required for the delivery driver to take from his or her current location in order to deliver the item to a locker.

In further embodiments, automatically establishing the wireless communication channel between the delivery driver's mobile computing device 180 and the locker bank computer 130 may preclude the delivery driver's need to approach and use the locker bank's computer directly 130 in order to deliver parcels to the locker bank. This may, for example, eliminate the need of the delivery driver having to: (1) scan a first parcel at the locker bank computer; (2) walk the first parcel from the locker bank computer to whichever locker is opened for delivery; (3) walk back to the locker bank computer; (4) scan a second parcel at the locker bank computer; and (5) so on, until the delivery driver has delivered all of his or her parcels at the locker bank.

As may be understood by one skilled in the art, eliminating even a single or a few steps by the delivery driver over the course of a day, when extrapolated over a period of time and plurality of other delivery drivers, may provide a meaningful increase in the productivity of delivery drivers, and other benefits to logistics providers or others who may implement a remote locker bank control system 110 such as the various embodiments of a remote locker bank control system 110 described herein.

### Exemplary Technical Platforms

As will be appreciated by one skilled in the relevant field, a system for initiating a wireless communication channel between a mobile computing device and one or more computerized locker banks (e.g., or other alternate delivery locations) may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web, mobile, wearable computer-implemented, computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

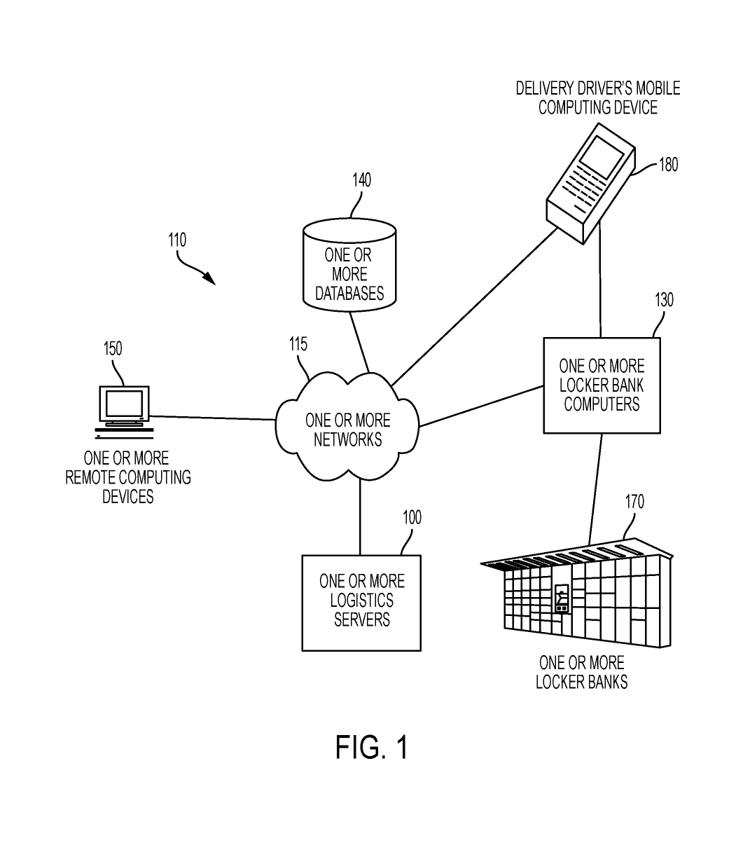

FIG. 1 is a block diagram of a remote locker bank control system 110 according to a particular embodiment. As may be understood from this figure, the remote locker bank control system 110 includes one or more computer networks 115, one or more logistics servers 100, one or more databases 140, and one or more locker bank computers 130 operatively coupled to one or more locker banks 170 and optionally in direct, wireless communication with a delivery driver's mobile computing device 180. The remote locker bank control system 110 also, in the embodiment shown in this figure, includes one or more remote computing devices 150, such as a tablet computer, a desktop or laptop computer, a handheld computing device such as a smart phone, etc. In particular embodiments, the one or more computer networks 115 facilitate communication between the logistics server 100, one or more databases 140, one or more locker bank computers 130, one or more locker banks 170, one or more remote computing devices 150, and the delivery driver's mobile computing device 180.

In particular embodiments, the one or more remote computing devices 150 are configured to access the one or more databases 140 (e.g., via the one or more networks 115) to retrieve package level detail information (e.g., PLD information) for one or more parcels. In various embodiments, the PLD information may comprise, for example consignee and/or shipper information associated with each of the one of the one or more parcels such as: (1) a name of the consignee for each parcel; (2) an address of the consignee for each parcel; (3) an account number for a consignee account that the consignee has with the shipper of each parcel; (4) a return address of each parcel; (5); contact information associated with the consignee of each parcel (e.g., telephone number, e-mail address, etc.); and/or any other suitable information associated with each parcel's consignee or shipper. In further embodiments, the PLD information may comprise information associated with each of the one or more parcels such as, for example: (1) a description of one or more items shipped in each parcel; (2) a number of the one or more items in each parcel; (3) a weight of each parcel; (4) a size of each parcel (e.g., including dimensions such as length, width, and height); (5) a value of the one or more items in each parcel; and/or (6) any other suitable information associated with each of the one or more parcels themselves or the one or more items within. In still other embodiments, the PLD information may comprise shipping information associated with each of the one or more parcels such as, for example; (1) service level (e.g., overnight shipping, two-day shipping, ground shipping, etc.); (2) one or more special handling instructions (e.g., fragile, one or more temperature requirements, one or more special monitoring or tracking requirements, etc.); and/or (3) any other suitable shipping information associated with the one or more parcels. In various embodiments, the one or more remote computing devices 150 are configured to retrieve at least a portion the PLD information using a unique tracking number associated with each of the one or more parcels.

The one or more remote computing devices 150 may, for example, enable a consignee to retrieve tracking information for one or more parcels that are currently scheduled for delivery, for example, to determine a delivery date/time, a delivery location, etc. The consignee may also use the one or more remote computing devices 150 to view changes in tracking information (e.g., such as when a parcel is routed from a primary delivery location to an alternate delivery location), request a change in delivery for a particular parcel, or perform any other function related to one or more logistics services or providers (e.g., logging into an account associated with a particular logistics provider such as a UPS MyChoice account, etc.).

In various embodiments, the one or more locker banks 170 may include a network of computerized locker banks. For example, a particular network of computerized locker banks may serve as alternate delivery locations for a particular area or region (e.g., such as a city, a zip code, neighborhood, subdivision, apartment building, etc.). In various embodiments, a particular logistics provider may operate the network of locker banks. In other embodiments, a third party company may operate the network and enable one or more other logistics providers to utilize the one or more locker banks 170 within the network. In such embodiments, the remote locker bank control system 110 (e.g., or any of its components such as those shown in FIG. 1) may, for example, be configured to interface with one or more third party devices such as a third party computing device (not shown), a third party logistics server (not shown), etc.

The one or more computer networks 115 may include any of a variety of types of wired or wireless computer networks such as the Internet (or other WAN), a private intranet, a public switch telephone network (PSTN), a mesh network, or any other type of network (e.g., a network that uses Bluetooth (standard or low energy Bluetooth), beacon communication technologies (e.g., iBeacon), and/or near field communications to facilitate communication between computing devices). The communication link between the logistics server 100, database 140, one or more locker bank computers 130, one or more locker banks 170, one or more remote computing devices 150 and the delivery driver's mobile computing device 180 may be, for example, implemented via a Local Area Network (LAN) or via the Internet (or other WAN). In particular embodiments, a communication link (e.g., a wireless communication link) between the one or more locker bank computers 130 and the delivery driver's mobile computing device 180 may be implemented via any suitable beacon communication technology (e.g., iBeacon) or any other suitable wireless communication link (e.g., WIFI, Bluetooth, infrared, NFC, IEEE 802.15.4, ZigBee, etc.).

In various embodiments, while the one or more locker bank computers 130 are in wireless communication (e.g., direct wireless communication) with the delivery driver's mobile computing device 180, the delivery driver's mobile computing device 180 is configured to operate as an input device for the one or more locker bank computers 130. In particular embodiments of a remote locker bank control system, the one or more locker bank computers 130 and the delivery driver's mobile computing device 180 are in bi-directional wireless communication with one another (e.g., the one or more locker bank computers 130 and the delivery driver's mobile computing device 180 may be configured to transmit and receive data, such as input data, to and from one another). In other embodiments, the wireless communication link between the one or more locker bank computers 130 and the delivery driver's mobile computing device 180 may be mono-directional (e.g., the delivery driver's mobile computing device 180 may be configured to transmit data and/or inputs to the one or more locker bank computers 130, while the one or more locker bank computers 130 are only configured to receive such data and inputs).

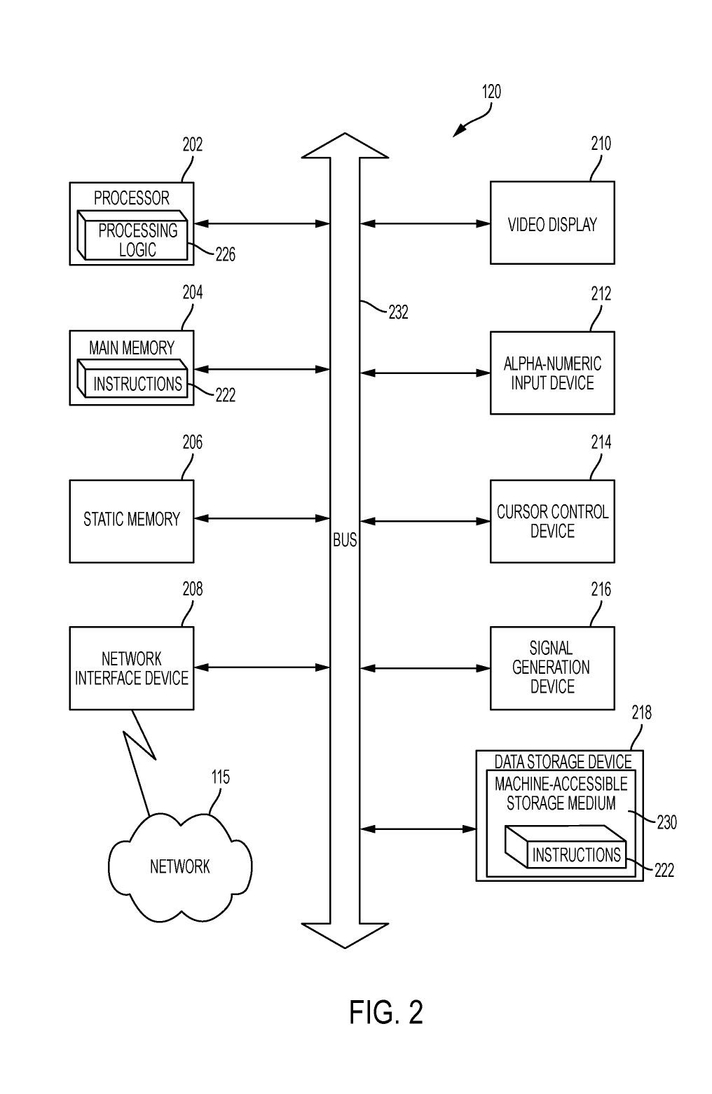

FIG. 2 illustrates a diagrammatic representation of a computer architecture 120 that can be used within the remote locker bank control system 110, for example, as a client computer (e.g., the delivery driver's mobile computing device 180 or the one or more remote computing devices 150 in FIG. 1), or as a server computer (e.g., the one or more logistics servers 100 shown in FIG. 1). In particular embodiments, the computer 120 may be suitable for use as a computer within the context of the remote locker bank control system 110 that is configured to facilitate routing of parcels to alternate delivery locations or facilitate the receipt and/or processing of parcels once they are delivered to the alternate delivery locations.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The computer 120 may be a personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-readable storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within main memory 204 and/or within processing device 202 during execution thereof by computer 120—main memory 204 and processing device 202 also constituting computer-accessible storage media. The software 222 may further be transmitted or received over a network 220 via network interface device 208.

While the computer-readable storage medium 230 is shown in an exemplary embodiment to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding or carrying a set of instructions for execution by the computer and that cause the computer to perform any one or more of the methodologies of the present invention. The term “computer-readable storage medium” should accordingly be understood to include, but not be limited to, solid-state memories, optical and magnetic media, etc.

### Exemplary Locker Bank

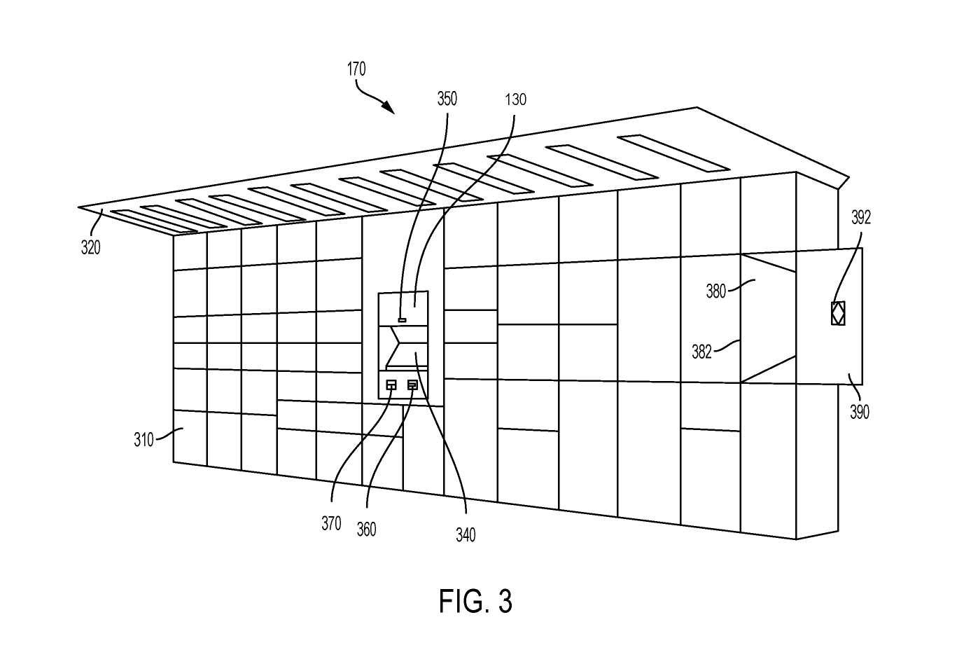

FIG. 3 depicts an exemplary locker bank 170 that may be used in the context of a remote locker bank control system 110 for the temporary storage of one or more parcels until their retrieval (e.g., by a consignee or another on the consignee's behalf). In the embodiment shown in this figure, the locker bank 170 comprises a locker bank computer 130 that users (e.g., such as delivery drivers or parcel consignees) may use to facilitate the placement of one or more items into the locker bank 170 and/or retrieval of one or more items from the locker bank 170, for example, in any manner described in this disclosure or in any other suitable manner. The locker bank computer 130, in a particular embodiment, comprises a touch-screen display 340, one or more imaging devices 350 (e.g., one or more cameras), a card reader 360, and a machine-readable indicia scanner 370 (e.g., a barcode scanner). The locker bank 170 further comprises an optional awning 320 that extends outwardly from an upper portion of the locker bank 100 and may provide at least partial protection to users from various weather conditions such as rain, snow, wind, and sun when the users are placing parcels into the locker bank 170 and/or retrieving parcels from the locker bank 170.

As shown in this figure, a locker bank 170, according to a particular embodiment, further comprises a plurality of lockers 310 of varying sizes (e.g., small, medium, large, etc.). In a particular embodiment, the locker bank 170 comprises one or more secure lockers (e.g., one or more selectively securable locker compartments), made of a sufficiently strong material to prevent unwanted access to the lockers (e.g., a suitable metal such as steel). In various embodiments, the secure lockers 310 of the locker bank 170 comprise any suitable number, size, shape, dimension, etc. For example, a particular locker bank may include 25 secure lockers of varying sizes and shapes that are configured to hold a variety of different sized items. In various embodiments, the arrangement of the secure lockers 310 may include any suitable arrangement. For example, a particular locker bank may have all large lockers on the outer edges of the locker bank with smaller lockers towards the center of the locker bank.

In various embodiments, the remote locker bank control system 110 is configured to store, in memory, for each of the one or more locker banks 170, data associated with the configuration of the locker bank. For example, in various embodiments, the system may be configured to store, in memory (e.g., in the one or more databases 140 or on the one or more logistics servers 100 shown in FIG. 1), data such as: (1) the arrangement of lockers within the locker bank (e.g., a grid or map of the lockers within the locker bank); (2) the dimensions of each particular locker in the locker bank; (3) dimensions of the particular locker bank (e.g., such as an overall height and width of the locker bank; (4) installation data associated with the locker bank (e.g., one or more GPS coordinates of the installed locker bank, an orientation of the installed locker bank such as relative to one or more cardinal directions, etc.); and/or (5) any other suitable configuration data that the system may use to determine, for example: (a) a distance between two lockers within the locker bank; (b) a distance between an object (e.g., such as a delivery driver's mobile computing device 180 shown in FIG. 1) or an individual and the locker bank or a particular locker in the locker bank; (c) etc.

In a particular embodiment, a locker bank comprises a plurality of secure lockers that each comprises an enclosure 380 (e.g., a substantially rectangular enclosure or any suitably shaped enclosure) defining at least one opening 382. In particular embodiments, each of the plurality of secure lockers enclosures 380 define an enclosure having particular dimensions (e.g., a height, a width, and a depth). In various embodiments, the at least one opening 380 defined by the enclosure 380 defines a particular sized opening (e.g., having a height and width). In various embodiments, the one or more secure lockers 310 each comprise at least one door 390 pivotably attached adjacent the opening 382 for selectively restricting access to an interior portion of the one or more lockers 310 (e.g., an interior portion of the enclosure). In particular embodiments, the at least one door 390 is positioned to selectively prevent access to the interior of the locker enclosure 380 through the at least one opening 382 when the at least one door 390 is in a closed position. In various embodiments, the at least one door 390 is configured, when in an open position, to provide access to the interior of the locker enclosure 380 through the at least one opening 382 as shown.

In various embodiments, the one or more lockers 310 further comprise at least one locking mechanism 392 for maintaining the at least one door 390 in the closed position. In particular embodiments, the locking mechanism 392 includes an electronically-controlled locking mechanism. In particular embodiments, the locker bank computer 130 is configured to engage or disengage the locking mechanism 392 (e.g., lock and unlock the locker) in order to provide or restrict access to the locker enclosure 380.

### Exemplary System Platform

Various embodiments of a system for establishing a wireless communication channel between a wireless computing device and a computerized locker bank for the purposes of facilitating delivery of items (e.g. parcels) to the computerized locker bank may be implemented within the context of any suitable service. For example, particular embodiments may be implemented within the context of any logistics service (e.g., such as those provided by United Parcel Service of America, Inc. of Atlanta, Ga.). Various aspects of the system's functionality may be executed by certain system modules, including a Parcel Delivery to Locker Bank Module 400. These modules are discussed in greater detail below.

It should be understood, in light of this disclosure, that the various functions described below in the context of the Parcel Delivery to Locker Bank Module 400 may be implemented in a manner other than the modular architecture described below. Various embodiments of these functions are described below in this manner to facilitate understanding of the invention described herein. Furthermore, while various embodiments described below may refer to various functions performed by the remote locker bank control system 110, it should be understood that such functions may be performed, in particular embodiments, by any suitable component of, or combination of components of the remote locker bank control system 110, such as those described above with respect to FIG. 1 (e.g., the one or more logistics servers 100, the locker bank computer 130, the one or more remote computing devices 150, the delivery driver's mobile computing device 180, etc.).

Additionally, although various steps and functions are described as occurring in response to another step, function, or triggering event, it should be understood that in various other embodiments, such functions or steps may occur in response to any other triggering functions or events; independent of any triggering functions or events; at least partially in response to any triggering functions or events; or in response to or at least partially in response to any combination of triggering functions, steps, events, etc. Although these exemplary modules are described as performing these functions in a particular order, it should be further understood that various other embodiments and implementations of these functions may occur in an order other than in which they are presented. Still other embodiments may omit particular steps or functions described below or perform additional steps or functions to those described.

Although for illustrative purposes, the system will be generally described in the context of parcel delivery to a computerized locker bank, it should be understood that other embodiments of the remote locker bank control system may be implemented in the context of any other suitable alternate delivery location system that may, for example, utilize attended or unattended alternate delivery locations as a temporary storage location for retrieval of parcels by consignees and others on their behalf. This may include, for example, any suitable location having one or more storage areas for holding items for later pickup. Particularly, these alternate delivery locations may include, for example, retail stores, gas stations, grocery stores, pharmacies, or any other suitable location. In various embodiments, these alternate delivery locations may include any suitable location other than a primary delivery address of a particular parcel. The primary delivery address may, for example, include a delivery address to which the particular parcel is initially addressed (e.g., by a sender of the particular parcel) such as, for example: (1) a home address of the parcel's consignee; (2) a work address of the parcels' consignee; (3) a vacation address of the parcel's consignee; (4) an address of a friend or relative of the parcel's consignee; (5) a locker bank convenient to the parcel's consignee; or (6) any other suitable location. In such embodiments, the alternate delivery location may include any suitable location to which the particular parcel is rerouted from the primary delivery address.

Parcel Delivery to Locker Bank Module

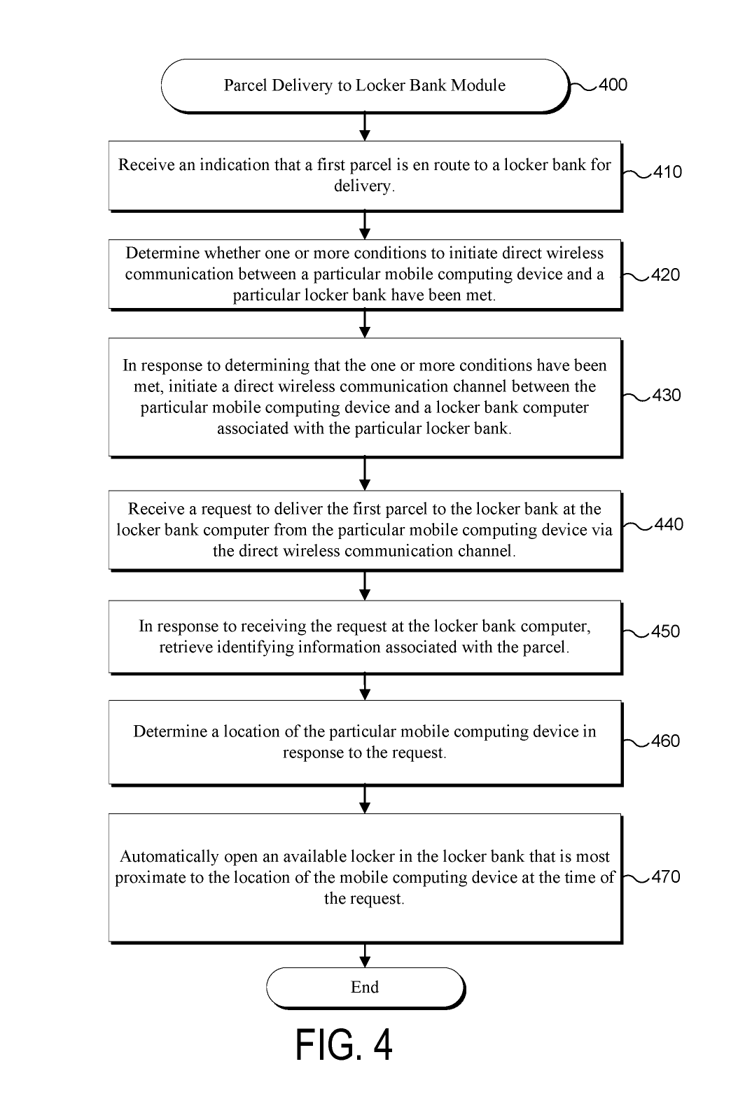

FIG. 4 is a flow chart of operations performed by an exemplary Parcel Delivery to Locker Bank Module 400. In particular embodiments, Parcel Delivery to Locker Bank Module 400 may facilitate the placement of parcels in a particular locker in a particular locker bank, for example, by representatives of carriers such as delivery drivers, employees at staffed locker banks (e.g., following delivery of the parcels to the staffed locker bank by a delivery driver), etc. In various embodiments, the system may use the Parcel Delivery to Locker Bank Module 400 to facilitate delivery of one or more parcels to a locker bank, for example: (1) following an unsuccessful delivery of the one or more parcels at another delivery location; (2) directly from a distribution hub or other distribution center; or (3) in any other suitable situation.

In various embodiments, once a delivery driver has arrived at a locker bank to deliver one or more parcels, the Parcel Delivery to Locker Bank Module 400 may facilitate the delivery of parcels to a locker bank by: (1) initiating a wireless communication channel between a wireless communication device and a locker bank computer; and (2) enabling an individual to remotely control or otherwise provide one or more inputs to the locker bank computer for the purposes of delivering parcels to or retrieving parcels from particular lockers in the locker bank. It should be understood that, while this module is generally described within the context of interaction between a delivery driver's mobile computing device 180 and a locker bank, it should be understood that various embodiments of the remote locker bank control system 110 may be implemented to facilitate wireless communication between a locker bank computer 130 and any other suitable wireless computing device (e.g., a consignee's wireless computing device such as a smart phone, or any other suitable remote computing device 150).

I. Receive an Indication that a First Parcel is En Route to a Locker Bank for Delivery

When executing the Parcel Delivery to Locker Bank Module 400, the remote locker bank control system 110 begins at Step 410, by receiving an indication that a first parcel is en route to a locker bank for delivery. In particular embodiments, the remote locker bank control system 110 is configured to receive the indication based on package level detail information for the first parcel. For example, the package level detail information may include a destination address of the first parcel, tracking information for the first parcel, etc. The remote locker bank control system 110 may, in various embodiments, receive the indication that the first parcel is en route to the locker bank for delivery based on the tracking information. For example, during the delivery process, the first parcel may be scanned at particular points of the process such as, for example: (1) a point at which the parcel arrives at a local or regional destination hub; (2) a point at which the first parcel is loaded onto a delivery vehicle (e.g., a point at which the first parcel is “out for delivery”); etc. In various embodiment, in response to a scan of the first parcel, the remote locker bank control system 110 may update tracking information associated with the first parcel (e.g., the PLD information) in the one or more databases 140 to include a time and location of the scan.

In various embodiments, the system is configured to receive the indication from the delivery driver's mobile computing device 180. In other embodiments, the delivery driver's mobile computing device 180 transmits unsuccessful delivery event information (e.g., time and location information) to the remote locker bank control system 110, and, in response, receives an indication from the system associated with redirection of the parcel. In various embodiments, for example, the remote locker bank control system 110 is configured to facilitate the delivery of the first parcel following an unsuccessful delivery attempt(s) to a primary delivery address. In particular embodiments, an unsuccessful delivery attempt may include an attempt to deliver the first parcel (e.g., or other item.) that could not be completed due to one or more policies of a carrier that had attempted to make the delivery. For example, for the first parcel, delivery may have been unsuccessful at the primary delivery location because the intended recipient was not home and the shipper requires a signature for the delivery.

In various embodiments, following the unsuccessful delivery attempt, a delivery driver may scan the undeliverable item (e.g., parcel) using the delivery driver's mobile computing device 180 to alert the remote locker bank control system 110 that delivery of the parcel was unsuccessful. In response to receiving the alert, the remote locker bank control system 110 may then, in particular embodiments, determine a suitable locker bank location for delivery of the parcel. In various embodiments, the system is configured to determine the suitable locker bank location based on any suitable factor such as, for example: (1) a size of the parcel (e.g., a specified relative size of the parcel, such as small, medium, or large; the physical dimensions of the parcel; the parcel's dimensional weight, cube, etc.); (2) one or more preferences established by the delivery service provider, the intended recipient, the shipper, the shipping provider, etc.; (3) proximity to the primary delivery location; and/or (4) etc.

The remote locker bank control system 110 is then configured to: (1) direct the delivery driver to deliver the undeliverable item to the suitable locker bank by, for example, transmitting an indication to the delivery driver's mobile computing device; and (2) indicate to the locker bank computer of the suitable locker bank that the first parcel is en route. Suitable systems and methods that may be used for the routing of parcels to suitable locker banks following unsuccessful delivery attempts are described in detail in U.S. patent application Ser. No. 14/514,000 which was filed on Oct. 14, 2014 and entitled “Systems and Methods for Conveying a Parcel to a Consignee, For Example, After an Unsuccessful Delivery Attempt”, and which is hereby incorporated herein by reference in its entirety. In various embodiments, once the locker bank computer 130 (e.g., or logistics server 100) receive the indication that the first parcel is en route to the locker bank, the system may, for example: (1) reserve a particular locker in the locker bank for the first parcel; (2) store, in memory, information including a minimum sized locker (e.g., small, medium, large) required to store the first parcel (e.g., based on one or more dimensions of the first parcel); and/or (3) take any other suitable action.

II. Determine Whether One or More Conditions to Initiate Direct Wireless Communication Between a Particular Mobile Computing Device and a Particular Locker Bank have been Met

At Step 420, the remote locker bank control system 110 continues by determining whether one or more conditions have been met to initiate direct wireless communication between a particular mobile computing device and a particular locker bank. In various embodiments, the particular mobile computing device may be any suitable device (e.g., a mobile computing device, a wireless device such as a smart phone), such as the delivery's driver's mobile computing device 180 shown in FIG. 1. In various embodiments, the remote locker bank control system 110 is configured to provide a software application (e.g., a mobile app) for installation on the particular mobile computing device. In various embodiments, the software application is configured to facilitate the direct wireless connection between the particular mobile computing device 180 and the locker bank computer 130.

In various embodiments, the one or more conditions may include any suitable condition under which it would be beneficial to initiate wireless communication between the particular mobile computing device and the particular locker bank (e.g., the locker bank computer 130). In particular embodiments, the one or more conditions include one or more conditions related to a delivery driver's presence at the locker bank 170. In various embodiments, as will be understood by one skilled in the art, when a delivery driver is approaching the particular locker bank to deliver one or more parcels (e.g., or the delivery driver or a consignee is approaching the locker bank to retrieve one or more parcels), it may be beneficial to automatically initiate wireless communication between the delivery driver's mobile computing device 180 and the locker bank computer 130 at least before the delivery driver has arrived adjacent the locker bank ready to deliver the one or more parcels. For example, it may be beneficial to automatically establish the wireless communication channel as the delivery driver pulls up to the locker bank in his or her delivery truck, as the delivery driver is unloading one or more parcels for delivery at the locker bank, as the driver approaches the locker bank with the one or more parcels (e.g., carrying the one or more parcels, pushing the one or more parcels on a cart or trolley, etc.).

In particular embodiments, automatically establishing a direct wireless communication channel between the delivery driver's mobile computing device 180 and the locker bank computer 130 may preclude the delivery driver from having to log in to or otherwise utilize the locker bank computer 130 directly in order to deliver the first parcel (e.g., and any other parcels) to the locker bank. As will be understood by one skilled in the art, if the delivery driver is carrying one or more parcels while trying to use the locker bank computer 130, it may be cumbersome for the delivery driver to have to carry any parcels he or she is delivering to the locker bank while trying to use the locker bank computer's touch-screen display 340 to interact with the locker bank (e.g., and deliver the parcels).

In other embodiments, the remote locker bank control system 110 may establish the direct wireless communication channel between the mobile computing device and locker bank computer 130 in a manner other than automatically. For example, in particular embodiment, the remote locker bank control system 110 may establish the direct wireless communication channel in response to a request from the delivery driver. In other embodiments, the system is configured to require the delivery driver to enter a passcode (e.g., on the mobile computing device) or provide other authentication prior to establishing the communication channel.

In various embodiments, the remote locker bank control system 110 is configured to receive the one or more conditions (e.g., from a logistics provider), for example, at the one or more logistics servers 100. The remote locker bank control system 110 may, for example, enable a logistics provider or another entity associated with the locker bank 170 to define the one or more conditions.

Various examples of conditions under which the remote locker bank control system 110 may initiate direct wireless communication between the delivery driver's mobile computing device 180 and the locker bank computer 130 are described below. It should be understood that these examples are for illustrative purposes only and other suitable conditions for establishing direct wireless communication may occur to one skilled in the art. In particular embodiments, they one or more conditions may include, for example: (1) one or more conditions under which the system would automatically initiate (e.g., establish) the wireless communication channel; (2) one or more conditions under which the system would initiate (e.g., establish) the wireless communication channel following authentication of the mobile computing device; and (3) one or more conditions under which the system would initiate (e.g., establish) the wireless communication channel in response to a request to do so.

Automatic Initiation of Wireless Communication Channel

In various embodiments, the one or more conditions for initiating the wireless communication channel may include one or more conditions for automatically establishing direct wireless communication between the mobile computing device and the locker bank computer 130. These may include, for example: (1) a condition that the mobile computing device and the locker bank (e.g., the locker bank computer 130) are within a particular distance of one another (e.g., based on a GPS location of the mobile computing device); (2) a condition that a location of the mobile computing device has entered a range of a wireless receiver (e.g., wireless antenna) associated with the locker bank computer 130 (e.g., such as a Bluetooth wireless receiver, a WLAN receiver, etc.); (3) a condition that the mobile computing device and the locker bank computer 130 are within a range of a wireless transmitter associated with the mobile computing device; (4) a condition that one or more imaging devices associated with the locker bank have captured one or more images comprising the delivery driver, the delivery driver's vehicle, etc. (e.g., which may trigger an automatic initiation of wireless communication between the delivery driver's mobile computing device 180 and the locker bank computer 130); (5) a condition that one or more weight sensors (e.g., disposed in the floor adjacent the locker bank 170) have been activated by the presence of the delivery driver (e.g., because the delivery driver has stepped on the one or more weight sensors while approaching the locker bank 170); and/or (6) any other suitable condition.

In various embodiments, the delivery driver's mobile computing device 180 may be configured to monitor for available wireless connections via, for example, the software application installed on the mobile computing device. In such embodiments, the mobile computing device (e.g., using the software application) is configured to actively search for available wireless connectivity points (e.g., locker bank computers 130). For example, the software application may periodically or continuously search for wireless connections or cause the mobile computing device 180 to search for available wireless connections. In various embodiments, the system is configured to determine that the mobile computing device is in range of the wireless connection in response to the software application detecting an available wireless connection associated with the locker bank. The system (e.g., the software application) may, for example, monitor for one or more available WIFI connections associated with a locker bank, one or more available Bluetooth connections associated with the locker bank, etc. In this embodiments, the system may determine that the one or more conditions have been met in response to detecting an available wireless connection associated with the locker bank.

As mentioned above, the one or more conditions may include that the particular mobile computing device is within a particular distance of the locker bank. According to various embodiments, the system may determine that the particular mobile computing device is within a particular distance of the particular locker bank substantially automatically. For example, as the delivery driver approaches the locker, the system may automatically determine that the delivery driver's mobile computing device 180 is within a particular distance of the particular locker bank. In various embodiments, the system may, for example: (1) monitor the GPS location of the mobile computing device 180 periodically to determine if it is near the locker bank; (2) continuously monitor the GPS location of the mobile computing device 180 to determine if it comes near the locker bank; (3) etc. The system may, for example: (1) determine a current GPS location of the delivery driver's mobile computing device 180; and (2) determine, based on a known GPS location of the locker bank, whether the delivery driver's mobile computing device 180 is within the particular distance of the locker bank. In various embodiments, the particular distance may include any suitable distance such as, for example, a particular number of feet (e.g., between about 10 feet and 50 feet or any other suitable distance). In various embodiments, the system may determine whether the delivery driver's mobile computing device 180 has entered a geofenced area associated with the particular locker bank. In other embodiments, they system may utilize any other suitable geofencing technique to determine that the mobile computing device 180 is adjacent to (e.g., within the particular distance of) a particular locker bank.

According to various embodiments, the system may determine that the particular mobile computing device is within the particular distance of the particular locker bank using any suitable location technique (e.g., based on GPS coordinates of the mobile computing device, and/or via near field communication (NFC), Bluetooth, iBeacon, or any other suitable wireless communication protocol) and/or based on a location of a delivery vehicle associated with the delivery driver (e.g. using one or more similar techniques for determining the location of the mobile computing device). In particular embodiments, the system is configured to use one or more triangulation techniques for determining a location of the mobile computing device in order to determine whether the mobile computing device is within the particular distance. For example, in various embodiments, the system may include a plurality of Bluetooth access points or other suitable wireless access points or wireless antennae (e.g., at least three Bluetooth or other wireless access points) to triangulate a location of the mobile computing device. The system may, for example, triangulate the location based on a connection between the mobile computing device 180 and the plurality of wireless access points.

In various embodiments, the locker bank may comprise one or more imaging devices. In particular embodiments, the system is configured to use the one or more imaging devices to capture one or more images (e.g., video images). The system may, for example, continuously or periodically capture one or more images of an area surrounding the locker bank. In various embodiments, the system may be configured to perform image analysis using any suitable digital image processing technique to identify that a delivery driver (e.g., or delivery vehicle) is adjacent the locker bank. The system may identify the delivery driver by, for example, a particular color pattern or logo of the delivery driver's uniform in the one or more images (e.g., a particular shade of brown), or in any other suitable manner. In particular embodiments, the one or more conditions include one or more conditions related to detecting motion using the one or more imaging devices while a determined location of the delivery driver (e.g., or the delivery driver's mobile computing device 180 or delivery vehicle) is near the locker bank. This may, for example, indicate that the driver is approaching the locker bank to deliver one or more parcels.

Authentication of Mobile Computing Device as Condition to Initiation of Wireless Communication Channel

In various embodiments, the system is configured to authenticate a particular mobile computing device as one of the one or more conditions for initiating the wireless communication channel between the mobile computing device and the locker bank computer 130. For example, in various embodiments, in response to determining that the delivery driver is at the locker bank (e.g., using any of the one or more techniques described above), the system may prompt the delivery driver to enter one or more credentials associated with the delivery driver. For example, the system may prompt the driver to enter, using the delivery driver's mobile computing device 180 (e.g., or the locker bank computer 130), a pass code, pin number, or other identifying information to confirm that the delivery driver is authorized to access the locker bank using the remote computing device.

In other embodiments, in response to determining that the delivery driver is at the locker bank, the system may prompt the delivery driver to scan a machine-readable indicia associated with the mobile computing device 180, for example, using the locker bank computer's machine-readable indicia scanner 370. In various embodiments the delivery driver's mobile computing device 180 may comprise a machine-readable indicia (e.g., in the form of a sticker). In other embodiments, the mobile computing device 180 is configured to display the machine-readable indicia on a display screen associated with the mobile computing device 180 (e.g., in response to determining that the mobile computing device 180 is in range of the locker bank 170). In other embodiments, the system is configured to utilize one or more RSA tokens or other suitable two-factor authentication devices or software tokens in order to authenticate the delivery driver's mobile computing device 180.

Initiation of Wireless Communication Channel in Response to Driver Request

In various embodiments, the system is configured to enable the delivery driver to manually indicate to the system that he or she is at the particular locker bank. The mobile computing device 180 may, for example, include a user-interface for selecting a particular locker bank. The system may display, via the user-interface a map comprising one or more locker banks that are near to the delivery driver. The driver may then select the locker bank at which he or she is located. In some other embodiments, the system is configured to receive confirmation of the driver's location at a particular locker bank in any other suitable way (e.g., selection of an indicia by the delivery driver on their mobile computing device 180 or on the locker bank computer 130, the delivery driver logging into the locker bank computer 130, etc.). In such embodiments, the one or more conditions may include a condition that the delivery driver has provided the location of the locker bank at which he or she is located, that the delivery driver has requested initiation of direct wireless communication between his or her mobile computing device 180 and the locker bank computer 130, etc.

III. In Response to Determining that the One or More Conditions have been Met, Initiate (e.g., Establish) a Wireless Communication Channel Between the Particular Mobile Computing Device and the Locker Bank Computer

At Step 430, the system continues by, at least partially in response to determining that the one or more conditions have been met, initiating a wireless communication channel between the particular mobile computing device and a locker bank computer associated with the particular locker bank. In various embodiments, the wireless communication channel may be unidirectional or bidirectional. For example, in various embodiments, the wireless communication channel may be configured to transfer data and/or inputs: (1) from the particular mobile computing device 180 to the locker bank computer 130; (2) from the locker bank computer 130 to the particular mobile computing device 180; and/or (3) both from the particular mobile computing device 180 to the locker bank computer 130 and from the locker bank computer 130 to the particular mobile computing device 180.

In particular embodiments, the system may open the wireless communication channel substantially automatically in response to determining that the one or more conditions have been met at Step 420. In various embodiments, the system may, for example, initiate (establish) the wireless communication channel via, for example: (1) Bluetooth; (2) Low-energy Bluetooth; (3) WI-FI; (4) near-field communication; or (5) any other suitable wireless protocol.

In particular embodiments, the system is configured to open the wireless communication channel based at least in part on the one or more met conditions. For example, in response to determining that a condition that a Bluetooth-enabled mobile computing device is within range of a Bluetooth-enabled locker bank computer 130, the system may be configured to establish a wireless connection between the Bluetooth-enabled mobile computing and the locker bank computer 130 via Bluetooth. As another example, in response to determining that a mobile computing device is in range of a WIFI network associated with the locker bank computer 130, the system may be configured to establish a WIFI connection between the mobile computing device and the locker bank computer 130 via the WIFI network.

In some embodiments, the wireless communication channel may remain open substantially continuously in order to maintain the wireless communication channel between the particular mobile computing device 180 and the locker bank computer 130 associated with the particular locker bank as long as the one or more conditions are still met. In other embodiments, the wireless communication channel may remain open for a particular period of time. In some embodiments, the wireless communication channel may close when the system determines that the particular mobile computing device is no longer within a particular distance of the locker bank computer (e.g., when the mobile computing device is no longer in range of the wireless access point associated with the locker bank computer over which the wireless communication channel was established). In other embodiments, the system may close the wireless communication channel (e.g., cease direct wireless communication between the mobile computing device 180 and the locker bank computer 130) in response to a request from the delivery driver.

In various embodiments, the wireless communication channel between the particular mobile computing device and the locker bank computer 130 may facilitate a transfer of any suitable type of data (e.g., audio data, input data, video data, image date, etc.) between the particular mobile computing device 180 and the locker bank computer 130. For example in various embodiments, the mobile computing device is configured to act as an input device for the locker bank computer. In such embodiments, the system may, for example, be configured to receive a request, at the mobile computing device, to deliver one or more parcels to the locker bank.

In other embodiments, a display screen of the mobile computing device 180 may mirror a touch-screen display 340 of the locker bank computer 130. In such embodiments, the system may mirror inputs received at the mobile computing device 180 and treat those inputs as inputs on the touch-screen display 340 of the locker bank computer 130. For example, a delivery driver may utilize his or her mobile computing device 180 to perform any function that could be performed using the locker bank computer 130 (e.g., requesting to deliver one or more parcels, etc.). The system may, in such embodiments, transmit the input received at the mobile communication device 180 over the wireless communication channel to the locker bank computer 130.

IV. Receive a Request to Deliver the First Parcel to the Locker Bank from the Particular Mobile Computing Device Via the Wireless Communication Channel

Continuing at Step 440, while the wireless communication channel is open, the system receives a request to deliver the first parcel to the locker bank from the particular mobile computing device via the wireless communication channel. In particular embodiments, the system receives the request at the locker bank computer 130. In various embodiments, the system receives the request in response to input from the particular mobile computing device via, for example, a touch screen of the mobile computing device, an imaging device or machine-readable indicia scanner of the mobile computing device, etc. In a particular embodiment, the system receives the request from the delivery driver's mobile computing device 180 (e.g., while the delivery driver's mobile computing device is in direct wireless communication with the locker bank computer 130).

In particular embodiments, the system may receive the request from a delivery driver, for example, in response to receiving, from the delivery driver, at least a portion of a tracking number (e.g., 1Z number) associated with the first parcel. The delivery driver may, for example, enter the at least a portion of the tracking number on a suitable alphanumeric entry device associated with the mobile computing device 180 (e.g., such as an on-screen or physical keyboard, touchscreen, etc.). In various embodiments, the at least a portion of the tracking number may include any suitable portion of the tracking number. For example, the suitable portion of the tracking number may include: (1) the first or last three digits and/or letters of the tracking number; (2) the first or last four digits and/or letters of the tracking number; (3) the first or last five digits and/or letters of the tracking number; (4) the first or last six digits and/or letters of the tracking number; and/or (5) any suitable number of letters or digits that make up any suitable portion of the tracking number (e.g., first three and last three, etc.).

In other embodiments, the system is configured to receive the request to deliver the first parcel to the locker bank at least partially in response to receiving input of a machine-readable indicia (e.g., such as a linear barcode, QR code, or other suitable indicia), which may, for example, be printed on the first parcel and associated with tracking information for the first parcel. In various embodiments, the mobile computing device 180 may comprise one or more machine-readable indicia scanners (e.g., such as a barcode scanner), configured to enable the delivery driver (e.g., or another) to scan a machine-readable indicia on a particular parcel (e.g., affixed to the particular parcel, printed on the particular parcel, etc.). In other embodiments, the mobile computing device may comprise one or more suitable imaging devices (e.g., one or more cameras) configured to read the machine-readable indicia. In particular embodiments, the system may retrieve information associated with the machine-readable information, such as, for example, tracking information for the particular parcel. In particular embodiments, the system is configured to interpret a scanning of a machine-readable indicia associated with a particular parcel by the mobile computing device 180 as a request to deliver the first parcel to the locker bank.

V. In Response to Receiving the Request at the Locker Bank Computer, Retrieve Identifying Information about the Parcel

Continuing to Step 450, the system, in response to receiving the request at the locker bank computer, retrieves identifying information associated with the first parcel. In various embodiments, the system is configured to retrieve the identifying information from one or more remote data stores (e.g., such as the one or more databases 140 or the one or more logistics servers 100 shown in FIG. 1). In various embodiments, the system may receive the identifying information as part of the request at Step 440. For example, in various embodiments, the system may receive the identifying information from the mobile computing device as part of the request. In such embodiments, receipt of the identifying information along with the request may preclude a need to retrieve the identifying information.

In some embodiments, the mobile computing device 180 may have retrieved the identifying information at an earlier time, such as in response to receiving an indication that delivery was not possible at a primary delivery location. In such embodiments, the system may have made a determination to route the first parcel to the locker bank in response to receiving the indication that delivery was not possible. The particular mobile computing device 180 may, at some time between receiving the indication that delivery was not possible and the delivery driver arriving at the locker bank, have retrieved the identifying information associated with the first parcel in anticipation of delivery of the first parcel to the locker bank.

In various embodiments, the identifying information may include package level detail information (PLD information) such as, for example: (1) one or more dimensions (e.g., length, width, and height) of the first parcel; (2) consignee information associated with the first parcel; and/or (3) any other suitable information.

VI. Determine a Location of the Particular Mobile Computing Device at the Time of the Request

Continuing at Step 460, the system determines a location of the particular mobile computing device at the time of the request. In particular embodiments, the system may determine the location of the particular mobile computing device at the time of the request using any suitable location determination technique (e.g., GPS, triangulation techniques, near field communication (NFC), Bluetooth, or any other suitable locating technique). The system may, for example, determine a location of the particular mobile computing device based on any combination of techniques. In various embodiments, the system may determine the location in response to the request.

In some embodiments, the system is configured to determine an geolocation of the mobile computing device 180 (e.g., a GPS location of the mobile computing device 180 including longitude and latitude of the mobile computing device). In other embodiments, the system is configured to determine a relative location of the mobile computing device (e.g., relative to the locker bank, relative to each particular locker in the locker bank, etc.).

In other embodiments, the system may be configured to use a plurality of Apple iBeacons (or other beacon devices or wireless access points or antennae) to triangulate a location of the mobile computing device (e.g., at least three Apple iBeacons or wireless access points). In other embodiments, the system is configured to use any other suitable triangulation technique or combination of techniques to determine a location of the particular mobile computing device. As may be understood by one skilled in the art, particular wireless protocols may not offer very high accuracy with regards to determining distances between a first device and a first wireless access point that are connected via such particular wireless protocols (e.g., such as via Bluetooth). In such embodiments, however, triangulating a location of the first device relative to a plurality of wireless access points to which the first device is wirelessly connected may offer sufficient location accuracy to determine a location of the first device (e.g., relative to the plurality of wireless access points) for the purposes of use with the system described herein.

In particular embodiments, the system may be configured to use a plurality of RFID tags disposed adjacent the locker bank. For example, the locker bank may comprise an RFID tag adjacent every locker in the locker bank, every column of lockers in the locker bank, every row of lockers in the locker bank, etc. In such embodiments, the mobile computing device 180 may serve as an RFID interrogator configured to read the RFID tags. The system may then use readings of the RFID tags by the mobile computing device 180 to determine the location of the mobile computing device 180 relative to the locker bank.

In other embodiments, the system may utilize any other suitable proximity sensor to determine a location of the mobile computing device 180 or the delivery driver. This may include, for example, one or more light arrays disposed adjacent (e.g., in front of) the locker bank. In various embodiments, the light array may comprise an array of light beams, with at least one beam disposed adjacent each column of lockers in the locker bank (e.g., to detect a delivery driver or other individual's proximity to a particular column of lockers).

In various embodiments, the system may determine the location of the particular mobile computing device by determining how quickly the request from the particular mobile computing device is transmitted via the wireless communication channel to the locker bank computer. The system may, for example, compare a transmission time of the request from the mobile computing device and a receipt time of the request at the locker bank computer to determine a distance between the two. For example, in various embodiments, the system may determine the distance based on the type of wireless communication channel, known transfer speed over the wireless communication channel, known latency over the wireless communication channel, radio frequency of the wireless communication channel, etc.

In still other embodiments, the system is configured to determine the location of the mobile computing device 180 at a time other than the time of the request. For example, the system may be configured to determine the location immediately following the request, relatively soon after the request or at any suitable other time. In particular embodiments, the system may be configured to determine the location of the mobile computing device 180 after the request (e.g., within about one second of the request, within about two seconds of the request, within about three seconds of the request, within about four seconds of the request, between about the time of the request and about fifteen seconds after the time of the request).

VII. Automatically Open an Available Locker that is Most Proximate to the Location of the Mobile Computing Device at the Time of the Request

Next, at Step 470, the system automatically opens an available locker that is most proximate to the location of the mobile computing device at the time of the request to deliver the first parcel. In various embodiments, an available locker may include a locker that is not currently housing another parcel and/or item. In various embodiments, opening the most proximate locker may enable the delivery driver to deliver the first parcel to the locker while minimizing a number of steps that the delivery driver needs to take between requesting delivery using the mobile computing device 180 and placing the first parcel into the locker.

In various embodiments, the system may determine the locker that is most proximate the location of the mobile computing device by comparing the location of the mobile computing device at the time of the request to a location of each available locker in the particular locker bank. For example, the system may determine the most proximate locker based on the location of the mobile computing device and a known layout of the locker bank (e.g., which the system may store in memory). In some embodiments, the system may determine the most proximate locker based on an absolute location of the mobile computing device and a GPS location and orientation of the locker bank. For example, for a locker bank that is oriented North to South, the system may determine, for a mobile computing device that is slightly south of the locker bank at the time of the request, that the most proximate locker is in a Southern portion of the locker bank. As discussed above, the system may store configuration data for particular locker banks. The system may use this configuration in combination with a relative position of the mobile computing device 180 and locker bank 170 to determine a most proximate locker.

In particular embodiments, the system may comprise a wireless access point (e.g., an iBeacon, or other suitable access point or antenna) associated with each locker in the locker bank. For example, the system may comprise a wireless access point disposed adjacent each particular locker. In various embodiments, the system may be configured to determine a distance between the mobile computing device and each particular wireless access point (e.g., each particular locker in the locker bank) to determine the most proximate locker.

In some embodiments, the system may determine the locker that is most proximate the location of the mobile computing device based on a vertical and horizontal proximity to the mobile computing device. For example, the system may determine that a locker that is one foot over and at the same height as the mobile computing device is more proximate to the mobile computing device than a locker that is one foot over but one foot above the height of the mobile computing device. In particular embodiments, the system may determine the locker that is most proximate the location of the mobile computing device based on an accessibility rating of one or more available lockers. For example, lockers that are near the top of the particular locker bank and lockers that are near the bottom of the particular locker bank may be given a lower accessibility rating than lockers that are in the middle row of the particular locker bank. In various other embodiments, the system may determine a locker that is most proximate based on a lateral distance (e.g., without accounting for a position of a particular locker within a column of lockers in the locker bank).

According to various embodiments, the system may automatically open the available proximate locker using the locker bank computer, which may be, in some embodiments, configured to control access to each particular locker in the locker bank, for example, via one or more locking mechanisms associated with each particular locker. In particular embodiments, the system is configured to automatically open the available locker by unlocking a locking mechanism associated with the available locker. The one or more locker bank computers 130 may, for example, cause a locker's locker mechanism 392 to disengage and activate an actuator or other device (e.g., such as a suitable biasing mechanism) to at least partially open the locker's door 390. In various embodiments, each locker may be equipped with one or more indicators (e.g., one or more indicators for each particular locker) that are configured to indicate when a particular locker in the locker bank is unlocked. For example, each particular locker may have an associated indicator light adjacent the particular locker that the system (e.g., the locker bank computer 130) is configured to turn on when the locker is unlocked.

In particular embodiments, after the system has automatically opened the available locker, the system may alert the delivery driver to close the locker once the parcel has been placed inside the locker. In various embodiments, the system may provide the alert by, for example, transmitting the alert from the locker bank computer 130 to the delivery′ driver's mobile computing device 180 via the wireless communication channel. In some embodiments, the system may automatically lock the locker after determining that the door of the locker has been moved from an open position to a closed position (e.g., after the first parcel has been placed within the locker). In other embodiments, the system may require the delivery driver to select a lock button in order to lock the locker (e.g., a lock button-indicia on the mobile computing device 180 or locker bank computer 130). In such embodiments, the system may, for example, receive an indication that the first parcel has been placed in the locker from the delivery driver's mobile computing device 180 in a manner similar to that described above with regard to receiving the request to deliver the first parcel at the locker bank (e.g., via the wireless communication channel). In various embodiments, in response to determining that the first parcel has been placed in the locker and the locker door has been closed (e.g., and locked), the system may associate the first parcel with the locker bank in memory (e.g., by updating tracking information associated with the first parcel, by storing the association in the one or more databases 140, etc.).

In various embodiments, in addition to determining which locker to open based on proximity, the system may, for example, determine whether a locker is at least sufficiently large to accommodate the parcel based on the one or more dimensions of the parcel. Suitable systems and methods that may be used for facilitating the selection and opening of an appropriately sized locker at a locker bank are described in detail in U.S. patent application Ser. No. 14/514,155, which was filed on Oct. 14, 2014 and entitled “Systems and Methods for Facilitating Delivery of a Parcel to Suitably-Sized Locker”, and which is hereby incorporated herein by reference in its entirety. As may be understood by one skilled in the art, those techniques may be combined with the techniques described herein relating to locker proximity to ensure that the most proximate available locker is also sufficiently large to fit the parcel.

In still other embodiments, the system may be configure to automatically open a locker that the system reserved at some time prior to the request to deliver the parcel received from the mobile computing device 180. For example, following an unsuccessful delivery at a primary delivery location, the system may be configured to: (1) route a parcel to a particular locker bank; (2) reserve a particular locker at the locker bank for the parcel; (3) automatically initiate direct wireless communication (e.g., via a wireless communication channel) between a driver's mobile computing device 180 and a locker bank computer 130 associated with the particular locker bank when the driver arrives to deliver the parcel; and (4) automatically open (e.g., unlock) the particular reserved locker in response to receiving a request to deliver (e.g., a scan of) the parcel at the locker bank computer 130 from the mobile computing device 180 via the direct wireless communication channel.

### Exemplary Delivery Driver Experience

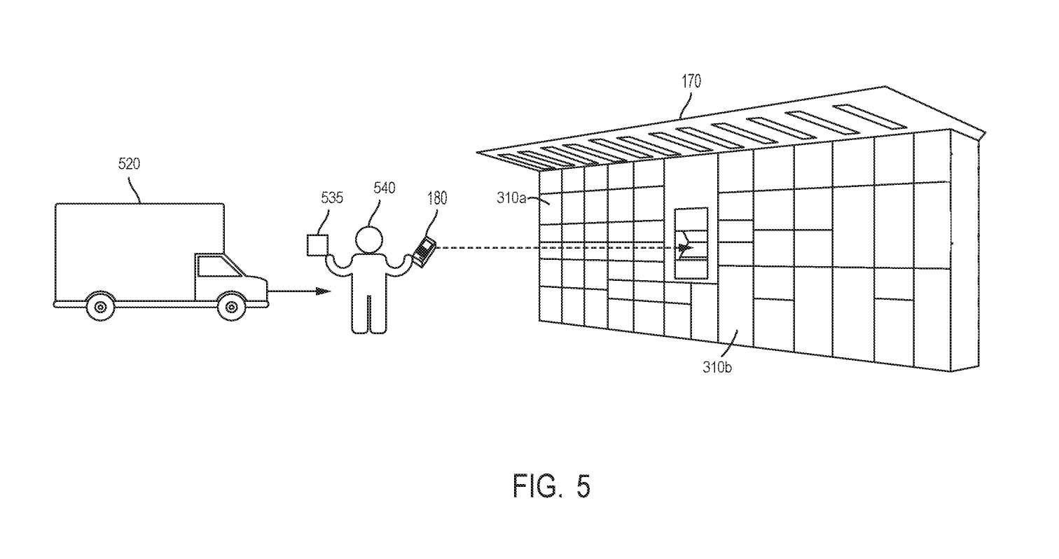

FIG. 5 shows an exemplary experience of a delivery driver 540 delivering a parcel 535 to a locker bank 170 using a particular embodiment of the remote locker bank control system 110 described above. As shown in this figure, the delivery driver 540 may arrive at a locker bank 170 (e.g., in their delivery vehicle 520) with the parcel 535 and their mobile computing device 180.

The driver 540 may have arrived at the locker bank 170 following an unsuccessful delivery attempt of the parcel 535 at another delivery location (e.g., such as a primary delivery location of the parcel's consignee). As the driver 540 approaches the locker bank 170, the system determines whether one or more conditions exist for establishing a direct communication channel between the driver's mobile computing device 180 and the locker bank's locker bank computer 130. In various embodiments, the one or more conditions may include any of the one or more conditions described above or any other suitable condition.

In a particular example, the one or more conditions include a condition that the delivery driver 540 is within a particular distance of the locker bank 170. Once the delivery driver 540 is within the particular distance of the locker bank 170, as determined using any suitable locating technology (e.g., GPS, beacon, RFID tag on the mobile computing device along with RFID tag readers on one or more of the lockers, etc.), the system automatically establishes a wireless communication channel between the mobile computing device 180 and the locker bank's computer 130.

Once the direct wireless communication channel has been established, the delivery driver 540 may scan the parcel 535 using the mobile computing device 180 as the driver approaches the locker bank 170. In particular embodiments, in response to the driver 540 scanning the parcel 535 using the mobile computing device 180, the mobile computing device 180 transmits a request, via the direct wireless communication channel, to the locker bank computer 130 to deliver the parcel 535 to the locker bank 170. At the time of the request (e.g., in response to the driver 540 scanning the parcel 535), the system determines the location of the delivery driver 540 (e.g., the location of the delivery driver's mobile computing device 180). In the embodiment shown in this figure, the system may determine that the delivery driver 540 is fifteen feet from the left side of the locker bank 170.

In response to receiving the request and determining the location of the delivery driver 540, the system is configured to automatically open a proximate locker 310a for delivery of the parcel 535. The delivery driver 540 can then place the parcel 535 in the locker 310a, close the locker, and repeat the process for any additional parcels that need to be delivered.

In some embodiments, the system may further determine a proximate locker that is sufficiently large to accommodate the parcel. If the parcel 735 were not small enough to fit in locker 310a, the system may determine that larger locker 310b is the proximate locker that is also large enough to accommodate the parcel.

### Alternative Embodiments

Various embodiments of a remote locker bank control system may include features in addition to those described above. Various exemplary alternative embodiments are described below.

Connectivity of Mobile Computing Devices with Plurality of Locker Banks within a Locker Bank Network

In various embodiments, the locker bank control system comprises one or more locker banks 170 as shown in FIG. 1. In particular embodiments, the one or more locker banks 170 (e.g., a plurality of locker banks) may include a network of computerized locker banks. For example, a particular network of computerized locker banks may serve as alternate delivery locations for a particular area or region (e.g., such as a city or neighborhood). In various embodiments, a particular logistics provider may operate the network of locker banks. In such embodiments, the logistics provider may provide a wireless computing device to each of their delivery drivers that is configured to directly wirelessly communicate with each particular locker bank within the network of locker banks. For example, as may be understood by one skilled in the art in light of this disclosure, the system may facilitate delivery using the delivery driver's mobile computing device 180 by substantially automatically initiating wireless communication between the mobile computing device 180 and a particular locker bank computer 130 associated with any locker bank within the network (e.g., in response to meeting any of the one or more conditions discussed above, such as the mobile computing device 180 being within a particular range of a wireless networking device associated with the locker bank). This way, the system may, for example, enable universal, automatic wireless control of any locker bank within the network of locker banks by one or more mobile computing devices.

In particular embodiments, the system may assign one or more unique identifiers to each particular locker bank within the network as well as one or more unique identifiers to each particular mobile computing device within the network (e.g., each mobile device assigned to a delivery driver). The system may then track which particular remote computing devices have connected with which particular locker banks via direct wireless communication and vice versa.

In particular embodiments, the system may, for example, provide a software application for installation on one or more mobile computing devices. Once installed on the one or more mobile computing devices, the software application may facilitate the automatic direct wireless connection between the one or more mobile computing devices and each particular locker bank within the network of locker banks.

In various embodiments, the system is configured to establish one or more wireless communication channels between a particular locker bank computer 130 and a plurality of mobile computing devices simultaneously. For example, if two delivery drivers are located within an area near a particular locker bank, the system may initiate: (1) wireless communication via a first wireless communication channel between the locker bank computer 130 and a first mobile computing device; and (2) wireless communication via a second wireless communication channel between the locker bank computer 130 and a second mobile computing device. In such embodiments, the system may be configured to enable both the first mobile computing device and the second mobile computing device associated with each delivery driver to communicate with the particular locker bank computer 130 via respective wireless communication channels substantially simultaneously (e.g., simultaneously). In further embodiments, such simultaneous direct wireless communication may enable multiple delivery drivers to deliver parcels to the same locker bank at substantially the same time.

Application of Remote Locker Bank Control System by Users Other than Delivery Drivers

In various embodiments, a remote locker bank control system 110 may be utilized by users other than a delivery driver. For example, consignees may utilize the system to retrieve parcels from the locker bank. The system may, for example, provide a software application for installation on a mobile computing device (e.g., such as the user's smart phone) which the user may use to access one or more lockers storing one or more parcels associated with the user. In various embodiments, the system is configured to enable the user to access the locker bank in any suitable manner described above, such as through a direct wireless communication channel between the user's mobile computing device and the locker bank computer 130.

In such embodiments, the system may, for example, automatically establish the wireless communication channel to connect the user's smart phone with the locker bank computer as the user approaches the locker bank. The user may then user their smart phone to release any parcels associated with the user that are stored in the locker bank. This may, for example, enable the user to avoid waiting in line to use the locker bank computer in order to pick up their parcels.

Multi-Parcel Delivery

In various embodiments, the system is configured to enable the delivery driver to utilize the system described above to deliver a plurality of parcels to a locker bank. The system may, for example, be configured to open additional proximate lockers in response to receiving requests to deliver multiple parcels (e.g., in response to the driver using their mobile computing device 180 to scan two or more parcels at the same time while at the locker bank). In still other embodiments, the system may enable the driver to deliver the parcels to the locker bank one at a time. In other embodiments, the system may open one locker per scanned parcel, and instruct the delivery driver to place the parcels in the lockers in the order in which they were scanned from closest locker to furthest.

### CONCLUSION

Many modifications and other embodiments of the invention will come to mind to one skilled in the art to which this invention pertains having the benefit of the teachings presented in the foregoing descriptions and the associated drawings. While examples discussed above cover the use of various embodiments in the context of the delivery of one or more parcels to a locker bank, various embodiments may be used in any other suitable context. For example, the various techniques used to effect remote control of a locker bank using a mobile device may be in any suitable parcel delivery or pickup context. Similarly, while various techniques described herein are described in conjunction with facilitating delivery of a parcel that was not successfully delivered on a first delivery attempt, such techniques may also be applicable in delivering parcels directly to a primary delivery location, such as a locker bank. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computerized locker network comprising:
a plurality of locker banks, each respective locker bank comprising:
one or more locker bank computers comprising one or more processors and memory; and
one or more selectively securable locker compartments, each selectively securable locker compartment comprising one or more doors and one or more locking mechanisms, wherein the one or more processors are configured to operate the one or more locking mechanisms to open the one or more doors;
a plurality of mobile computing devices, each respective mobile computing device comprising:
memory and one or more processors configured to establish a wireless communication channel between the respective mobile computing device and one or more particular locker bank computers in response to determining that the respective mobile computing device is adjacent to a particular locker bank of the plurality of locker banks that comprises the one or more particular locker bank computers; and
one or more remote logistics servers comprising:
memory that stores a unique identifier and tracking information for a plurality of parcels and one or more processors configured to update the tracking information for the plurality of parcels, wherein the computerized locker network is configured for:
determining whether the particular mobile computing device is proximate to the particular locker bank;
automatically forming a direct wireless communication channel between the particular mobile computing device and the one or more particular locker bank computers in response to determining that the particular mobile computing device is proximate to the particular locker bank;
receiving, from the particular mobile computing device, a request to deliver the particular parcel to the particular locker bank after automatically forming the wireless communication channel, the request comprising the unique identifier for the particular parcel;
in response to receiving the request, transmitting the unique identifier from the particular mobile computing device to the one or more particular locker bank computers via the direct wireless communication channel;
in response to transmitting the unique identifier from the particular mobile computing device to the one or more particular locker bank computers via the wireless communication channel:
automatically operating the one or more locking mechanisms of a particular locker at the particular locker bank to open the one or more doors of the particular locker.

2. The computerized locker network of claim 1, wherein determining whether the particular mobile computing device is proximate to the particular locker bank comprises determining whether the particular mobile computing device is within a range of an available wireless access point associated with the one or more particular locker bank computers.

3. The computerized locker network of claim 2, wherein:
the particular mobile computing device is further configured for actively searching for the available wireless access point; and
the computerized locker network is further configured for, in response to the particular mobile computing device detecting the available wireless access point, determining that the particular mobile computing device is in the range of the available wireless access point.

4. The computerized locker network of claim 2, wherein the one or more particular locker bank computers are configured to actively search for the particular mobile computing device.

5. The computerized locker network of claim 1, wherein determining whether the particular mobile computing device is proximate to the particular locker bank comprises determining whether the particular mobile computing device is within a particular distance of the particular locker bank.

6. The computerized locker network of claim 5, wherein:
the one or more remote logistics servers further comprise memory that stores location data associated with the particular locker bank; and
determining whether the particular mobile computing device is within the particular distance of the particular locker bank comprises:
determining a location of the particular mobile computing device; and
comparing the location of the particular mobile computing device with the location data associated with the particular locker bank to determine whether the particular mobile computing device is within the particular distance of the particular locker bank.

7. The computerized locker network of claim 1, wherein:
the computerized locker network is further configured for:
in response to the request to deliver the particular parcel to the particular locker bank, determining a location of the particular mobile computing device;
in response to transmitting the unique identifier from the particular mobile computing device to the one or more particular locker bank computers via the wireless communication channel, determining which locker of the one or more selectively securable locker compartments of the particular locker bank is a closest locker to the location of the particular mobile computing device; and
the particular locker is the closest locker.

8. The computerized locker bank of claim 7, wherein:
determining the location of the particular mobile computing device comprises determining a relative location of the particular mobile computing device relative to the particular locker bank;
the one or more remote logistics servers further comprise memory that stores locker configuration data associated with the particular locker bank;
the one or more particular locker bank computers comprise at least three wireless access points; and
the computerized locker network is further configured for:
using the at least three wireless access points to triangulate the relative location based on the locker configuration data; and
determining which locker of the one or more selectively securable locker compartments of the particular locker bank is the closest locker to the location of the particular mobile computing device comprises using the relative location of the particular mobile computing device relative to the particular locker bank to determine the closest locker.

9. The computerized locker bank of claim 7, wherein:
determining the location of the particular mobile computing device comprises determining a GPS location of the particular mobile computing device;
the one or more remote logistics servers further comprise memory that stores locker location data, locker orientation data, and locker configuration data associated with the particular locker bank;
the computerized locker network is further configured for:
determining which locker of the one or more selectively securable locker compartments of the particular locker bank is the closest locker to the location of the particular mobile computing device based on the GPS location of the particular mobile computing device, the locker location data, locker orientation data, and locker configuration data.

10. The computerized locker bank of claim 1, wherein automatically forming the direct wireless communication channel between the particular mobile computing device and the one or more particular locker bank computers comprises forming the direct wireless communication channel using a wireless protocol selected from the group consisting of:
WIFI;
Bluetooth;
ZigBee;
Beacon technology; and
Near-Field Communication.

11. A computer-implemented method of facilitating delivery of a first parcel to a locker bank comprising one or more lockers and a locker bank computer using a mobile computing device, the method comprising:
determining, by one or more processors, whether one or more wireless communication initiation conditions have been met;
at least partially in response to determining that the one or more wireless communication initiation conditions have been met, initiating, by one or more processors, a direct wireless communication channel between the mobile computing device and a locker bank computer associated with the locker bank;
receiving, by one or more processors, at the locker bank computer, a request to deliver the first parcel to the locker bank from the mobile computing device via the direct wireless communication channel;
in response to receiving the request to deliver the first parcel:
determining, by one or more processors, a location of the mobile computing device; and
determining, by one or more processors, based on the location of the mobile computing device, which of the one or more lockers is a closest locker to the location of the mobile computing device; and
automatically opening, by one or more processors, the closest locker.

12. The computer-implemented method of claim 11, wherein:
the one or more wireless communication initiation conditions comprise a condition that the mobile computing device is within a range of an available wireless access point associated with the locker bank computer;
the method further comprises:
providing, by one or more processors, a software application for installation on the mobile computing device, the software application causing the mobile computing device to actively search for the wireless access point; and
determining, by one or more processors, that the mobile computing device, using the software application, has detected the wireless access point; and
determining whether the one or more wireless communication initiation conditions have been met comprises determining that the one or more wireless communication initiation conditions have been met in response to determining that the mobile computing device has detected the wireless access point.

13. The computer-implemented method of claim 11, wherein:
the one or more wireless communication initiation conditions comprise a condition that the mobile computing device is within a particular distance of the locker bank; and
the method further comprises:
retrieving, by one or more processors, locker bank location data associated with the locker bank;
monitoring, by one or more processors, a GPS location of the mobile computing device; and
determining that the mobile computing device is within the particular distance of the locker bank by comparing the locker bank location data with the GPS location of the mobile computing device.

14. The computer-implemented method of claim 11, wherein:
the locker bank computer is operatively coupled to at least three wireless radio antennas; and
determining which of the one or more lockers is the most proximate locker to the location of the mobile computing device comprises determining a relative location of the mobile computing device and the locker bank based on a wireless connection between the mobile computing device and the at least three wireless radio antennas.

15. The computer-implemented method of claim 14, wherein the wireless connection is selected from the group consisting of:
WIFI;
Bluetooth;
ZigBee;
Beacon technology; and
Near-Field Communication.

16. The computer-implemented method of claim 11, wherein:
the one or more wireless communication initiation conditions comprise a condition requiring authentication of the mobile computing device; and
the method further comprises authenticating, by one or more processors, the mobile computing device using a software token stored on the mobile computing device.

17. The computer-implemented method of claim 11, wherein initiating the direct wireless communication channel between the mobile computing device and a locker bank computer associated with the locker bank comprises initiating the direct wireless communication channel based at least in part on the one or more wireless communication initiation conditions.

18. A locker delivery system comprising:
a locker bank computer associated with a locker bank comprising one or more processors and memory;
a mobile computing device comprising one or more processors and memory, wherein:
the locker bank comprises one or more selectively securable locker compartments, each selectively securable locker compartment comprising one or more doors and one or more locking mechanisms; and
the locker delivery system is configured for:
receiving an indication that a first parcel is scheduled for delivery at the locker bank;
retrieving identifying information associated with the first parcel, the identifying information comprising one or more dimensions of the first parcel;
determining whether one or more wireless communication initiation conditions have been met;
at least partially in response to determining that the one or more wireless communication initiation conditions have been met, initiating a direct wireless communication channel between the mobile computing device and the locker bank computer;
receiving, at the locker bank computer, a request to deliver the first parcel to the locker bank from the mobile computing device via the direct wireless communication channel;
in response to receiving the request to deliver the first parcel:
determining a location of the mobile computing device;
determining, based on the location of the mobile computing device and the one or more dimensions of the first parcel, which of the one or more selectively securable locker compartments is a closest locker to the location of the mobile computing device that is sufficiently large to accommodate the first parcel; and
causing the one or more locking mechanisms to unlock the one or more doors of the most proximate locker.

19. The locker delivery system of claim 18, wherein receiving the request to deliver the first parcel to the locker bank from the mobile computing device receiving a scan of a machine-readable indicia associated with the first parcel.

20. The locker delivery system of claim 18, wherein determining the location of the mobile computing device comprises determining the location of the mobile computing device using one or more triangulation techniques.
